(19) United States
(12) Patent Application Publication
(10) Pub. No.: US 2007/0094314 A1
(43) Pub. Date: Apr. 26, 2007

(54) Method for analyzing the storage capacity of a portable storage device

(76) Inventor: Hsiang-An Hsieh, Sindian City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/356,057

(22) Filed: Feb. 17, 2006

(30) Foreign Application Priority Data
Oct. 25, 2005 (TW) 94137352

(51) Int. Cl. G06F 17/30

(52) U.S. Cl. 707/205

(57) ABSTRACT

A method for analyzing the storage capacity of a portable storage device is disclosed. The volume allocation information is divided into multiple sections. The method directly accumulates pre-stored results of the sections that do not need to be updated and reads the sections of the storage medium that need to be updated to obtain the allocation information. A method for analyzing the storage capacity of a portable storage device starts a delay period to count time. During the delay period, the updating process is not executed. After the delay period is reached, the volume allocation information that has been changed during the delay period is updated in an accumulated manner. A method for analyzing the storage capacity of a portable storage device restricts the number of the scanned allocation information sections to enhance the efficiency of the normal accessing process.

### BACKGROUND OF THE INVENTION

1. Field of the Invention

The present invention relates to a method for analyzing the volume information of a portable storage device. In particular, this invention relates to a method for analyzing the storage capacity of a portable storage device.

2. Description of the Related Art

A portable storage device that can display the volume information utilizes the analyzing module of a controller to analyze the storage medium of the device for obtaining the storage volume information, such as the storage volume partition, the file system format, the remaining available capacity, and the volume label etc. Then, the analyzed information is displayed on the display device. Thereby, the user can view the storage volume information of the portable storage device to comprehend the usage status of the storage medium for additional convenience.

However, when a controller analyzes the storage medium, it is required to locate the file allocation information recorded onto the storage medium and to identify the file system format (such as FAT16, FAT32, NTFS and HFS etc.). By using the file allocation information, the allocation status of the data in the storage medium can be apprehended. After the allocation information is analyzed, the volume information is displayed on the display device. When the data is read/written on the storage medium, the data in the storage medium or the allocation of the data is changed. The allocation information is updated accordingly to correspond the changes made to the recorded content in the storage medium and to correctly indicate the allocated storage locations of data chunks recorded in storage medium.

Please refer to FIG. 1, which shows a flow chart of the updating of the allocation information of the prior art. When the data in the storage medium is read/written or accessed, the allocation information and the volume information are updated to display the updated volume information on the display device. Firstly, the portable storage device is linked with the host application system (computer) to start the communication protocol of the host application system (see step S101 as shown in FIG. 1). Next, whether the host application system sends an instruction or not is determined (see step S103 as shown in FIG. 1). If the host application system does not give an instruction, the portable storage device enters a stand-by status (see step S105 as shown in FIG. 1). If the host application system sends an instruction, whether the instruction is a read or status instruction or not is determined (see step S107 as shown in FIG. 1). If the instruction is a read or status instruction, the instruction is directly executed and the allocation information does not need to be updated (see step S109 as shown in FIG. 1), and the process returns to step S105. If the instruction is neither a read nor status instruction, whether the writing instruction changes the allocation information or not is determined (see step S111 as shown in FIG. 1). If the allocation information is not changed, the instruction is directly executed and the allocation information does not need to be updated (see step S109 as shown in FIG. 1), and the process returns to step S105. If the allocation information is changed, request to execute the updating process of the volume information is triggered (see step S113 as shown in FIG. 1). Then the writing instruction is executed and the data is transmitted (see step S115 as shown in FIG. 1). Because the volume information of the storage medium is changed, the updated volume information is read (see step S117 as shown in FIG. 1) from storage medium. The volume information stored in the volume information storage area is updated according to the updated volume information read from the storage medium (see step S119 as shown in FIG. 1). Then, the display content on the display device is updated according to the volume information stored in the volume information storage area (see step S121 as shown in FIG. 1). Finally, the portable storage device returns to a stand-by status (see step S123 as shown in FIG. 1).

Please refer to FIG. 2, which shows a process for updating the allocation information of the prior art. When the allocation information is changed due to the data being read/written or accessed in the storage medium, the process for updating the allocation information is executed (see step S201 as shown in FIG. 2). The file system format and the analysis method are identified via the file system identification (see step S203 as shown in FIG. 2). The start address and length of the allocation information are obtained, and the accumulated remaining available capacity is reset to zero (see step S205 as shown in FIG. 2). The allocation information is obtained by reading the storage medium and the obtained allocation information is transmitted to the data buffer (see step S207 as shown in FIG. 2). The data buffer is read to accumulate the remaining available capacity (see step S209 as shown in FIG. 2). Whether the scanning process is finished or not is determined (see step S211 as shown in FIG. 2). If the scanning process is not finished yet, the reading address and scanning length are incremented (see step S213 as shown in FIG. 2). If the scanning process is finished, the accumulated result is converted to the remaining available capacity in numeric format matching the display device requirement (see step S215 as shown in FIG. 2). Then, the display device interface is controlled to present the updated volume information (see step S217 as shown in FIG. 2). Finally, the updating and displaying process for the volume information is finished and the portable storage device returns to the stand-by status (see step S219 as shown in FIG. 2).

The updating and scanning of the allocation information is an important process for volume information analysis. However, when remaining available capacity is analyzed, especially in a storage medium with a large capacity and the allocation information occupy a large space, it takes a longer time to scan and update the allocation information via the controller of the portable storage device. Therefore, the time spent in the analyzing process is extended and the performance of accessing the portable storage device is affected.

Following is an example based on FAT32 file system. When the controller finds the file allocation table (indicating allocated recording location of data chunks of files and available recording space on storage medium) via the file system identification, the controller can rapidly find the data by referencing the file allocation table. When the storage capacity is one gigabyte, the size of the file allocation table is one million bytes. When the storage capacity is two gigabytes, the size of the file allocation table becomes two million bytes. Controller would require a long period of time to complete scanning of the one million bytes or two million bytes of file allocation table. Therefore, the accessing performance is affected. Furthermore, for storage devices with capacity more than two gigabytes, it will takes an even longer period of time to complete scanning the file allocation table. The accessing performance will be seriously affected.

### SUMMARY OF THE INVENTION

One particular aspect of the present invention is to provide a method for analyzing the storage capacity of a portable storage device. The volume allocation information is divided into multiple sections. A volume allocation information analysis result buffer is configured in the control unit for storing the analysis result of each section. When the host application system writes and changes specific sections of allocation information in storage volume, their corresponding entries in the analysis result buffer are marked to be updated. The other entries, with their corresponding sections of allocation information in storage medium remain intact, do not need to be updated and their recorded analysis result are directly accumulated. Where the analysis result entry is marked, the corresponding section of storage medium is accessed to acquire allocation information for calculation and analysis and to update the analysis result entry. With recorded analysis result in buffer, only those sections with a marked corresponding entry indicating allocation information that had been changed are accessed and scanned. The period of time needed to refresh the allocation information is reduced to improve accessing performance. The present invention also provides a method for analyzing the storage capacity of a portable storage device. When an updating process is firstly trigged by a writing operation, a delay timer is started to countdown a preset period of time. The updating process is not executed before the timer expire indicating the preset duration of time is reached after the first write operation triggering the timer. When the timer expire, all changes that have been made by write operation which affected volume allocation information during the delayed period of time are updated. By adopting a method of delayed trigger and processing affected volume allocation information in an accumulated batch, frequency of carrying out updating volume allocation information is reduced. Which may further reduce the impact to data access performance.

The present invention also provides a method for analyzing the storage capacity of a portable storage device. During the scanning and updating process, the number of processed sections is accumulated. If the accumulated number reaches a predetermined number indicating normal data access operation may be affected, the updating process for the volume allocation information is aborted and returns to the normal data accessing operation. Because the updated result for each section bas been recorded in the result buffer, in the next updating process, the updated sections are directly accumulated and only those yet to be updated sections are scanned and updated. Thereby, the maximum storage area that is scanned by the updating process is limited to a reasonable amount to separate excessive long scanning process to multiple run and prevent regular data access operation from being affected The present invention further provides a method for analyzing the storage capacity of a portable storage device. There is a specified area in the storage medium for recording the statistical result of the file allocation table. The storage device controller always stores the latest statistical result in the specified area whenever the updating process is triggered and completed. When the storage device is started from power-down next time, the latest update of statistical result that is recorded before shutting down the storage device is directly loaded into the controller from the storage medium. Preventing the needs to scan entire allocation information recording area to re-build and update volume allocation information when the storage device is re-started.

For further understanding of the invention, reference is made to the following detailed description illustrating the embodiments and examples of the invention. The description is only for illustrating the invention and is not intended to be considered limiting of the scope of the claim.

### BRIEF DESCRIPTION OF THE DRAWINGS

The drawings included herein provide a further understanding of the invention. A brief introduction of the drawings is as follows:

FIG. 1 is a flow chart of updating the allocation information of the prior art;

FIG. 2 is a flow chart of updating process for the allocation information of the prior art;

FIG. 3 is a schematic diagram of the volume allocation information divided into multiple sections which scanning results are temporarily stored of a preferred embodiment of the present invention;

FIG. 4 is a flow chart of restricting the number of scanning sections of the allocation information of a preferred embodiment of the present invention;

FIG. 5A is a schematic diagram of the operation for the volume information recording area of a preferred embodiment of the present invention;

FIG. 5B is a schematic diagram of another operation for the volume information recording area of a preferred embodiment of the present invention;

FIG. 6 is a time table of writing the data and triggering the updating process for the allocation information of a preferred embodiment of the present invention; and

FIG. 7 is a flow chart of delaying the trigger of updating process for the allocation information of a preferred embodiment of the present invention.

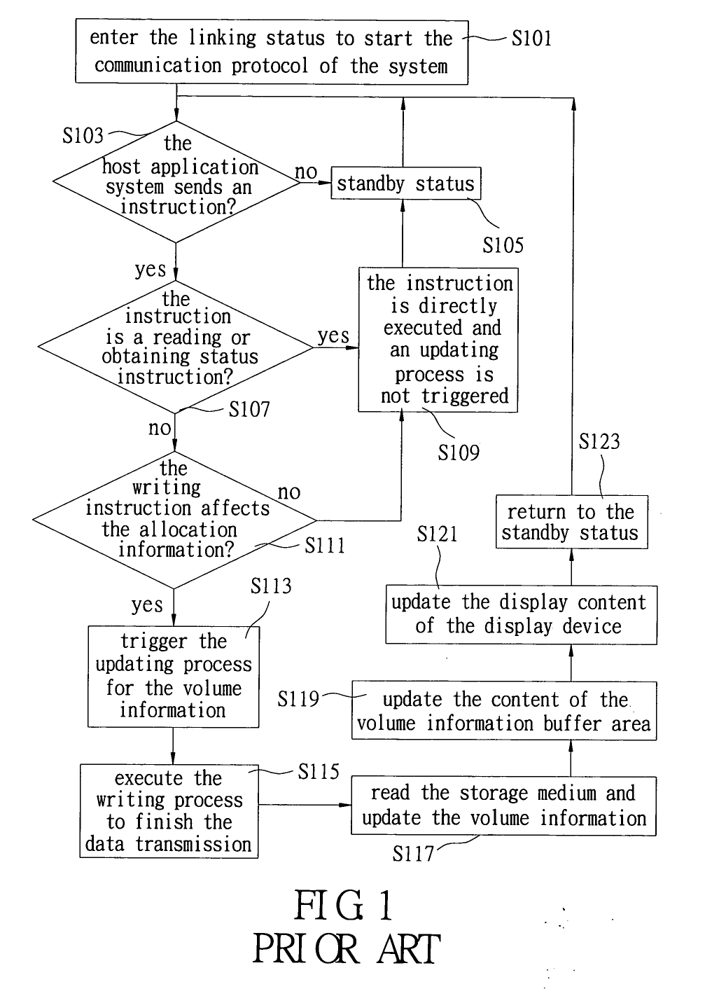

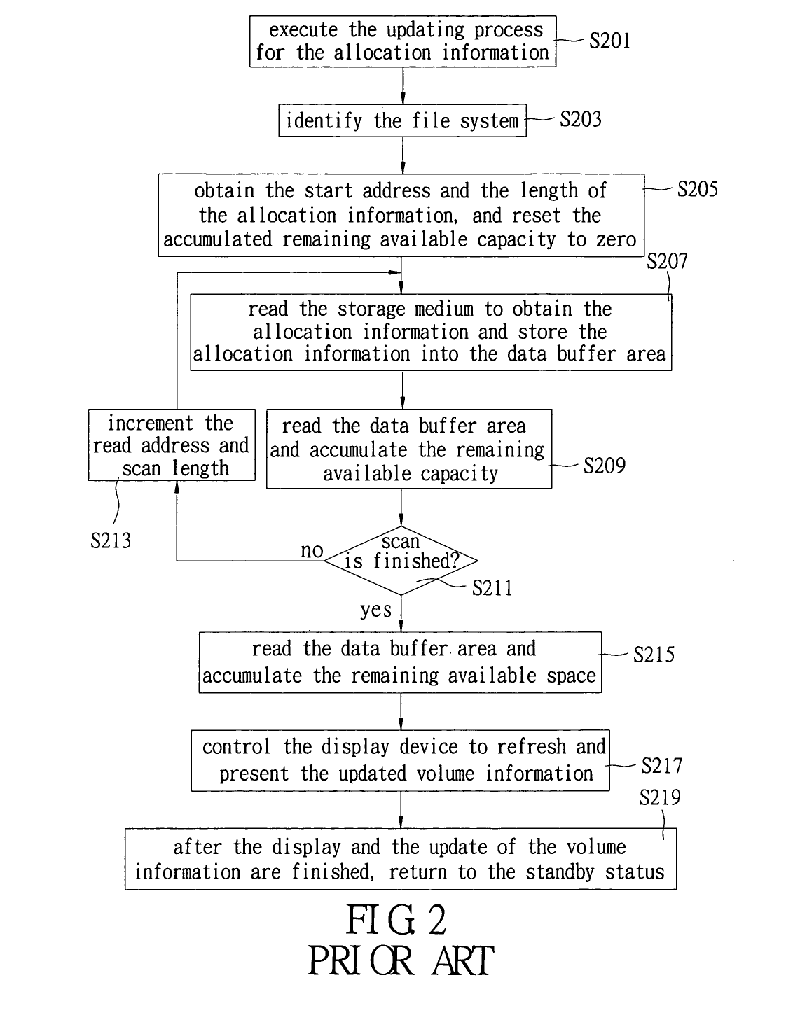

### DETAILED DESCRIPTION OF THE PREFERRED EMBODIMENTS

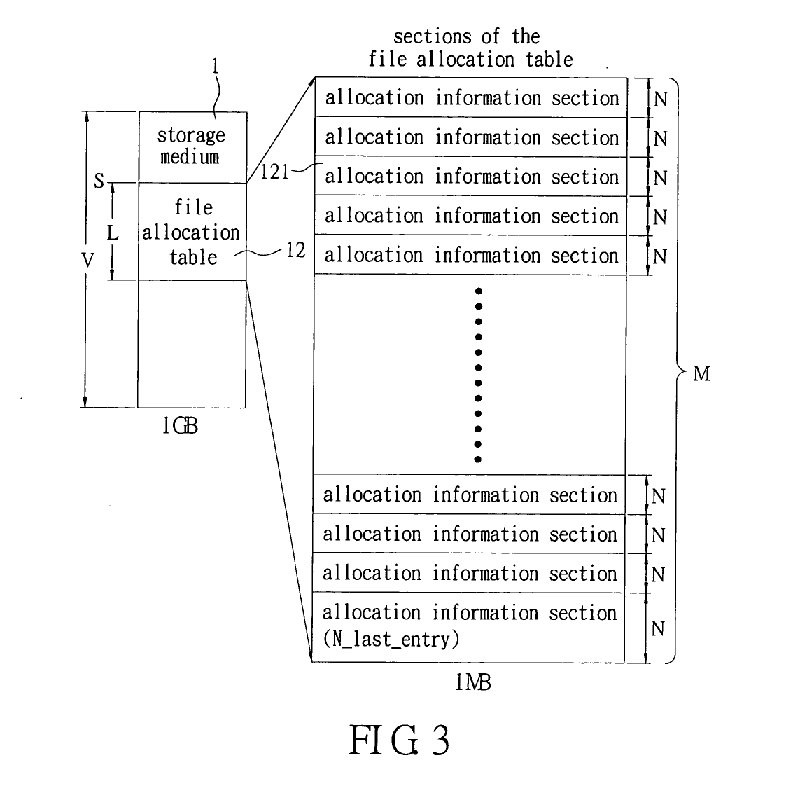

The controller scans the volume allocation information table in the portable storage device to comprehend the storage space allocation condition of the storage medium. When a system writes the data into the storage medium, the allocation information recorded in the storage medium is updated corresponding to the allocated storage location of written data. Then, the controller scans the allocation information to obtain the updated allocation information in the storage medium. Please refer to FIG. 3, which shows a schematic diagram of the volume allocation information divided into several sections which scanning results are temporarily stored of a preferred embodiment of the present invention. A storage medium 1 has a FAT32 format. The capacity of the storage medium is one gigabyte. The size of the allocation information table 12 is one million bytes (MB) and the allocation information area has 2048 sectors.

Firstly, the allocation information area is divided into 100 allocation information sections 121. Each allocation information section 121 has twenty sectors. Then, the capacity of the storage medium 1 is divided into 100 portions. Each portion is 10 MB. Therefore, when data under 10 MB is written into the storage medium 1, one corresponding allocation information section 121 in the allocation information table 12 is updated to represent that the corresponding storage medium has been modified. A specified mark is used for marking the allocation information section 121 to represent that the volume information analysis result (stored in buffer) corresponding to the allocation information section 121 needs to be updated. In other words, the corresponding result buffer entry for allocation information section 121 is marked by the specified mark to represents that the content of the allocation condition of the corresponding storage medium has been changed. The specified mark is used for identifying the updated volume information needing to be scanned and analyzed via the controller (not shown in the figure). For example, if corresponding entry of result buffer for one allocation information section 121 is marked with “1”, that means the corresponding storage medium has been changed and the volume information analysis result of the allocation information section 121 needs to be updated. If corresponding result buffer entry for one allocation information section 121 is marked with “0”, it means the corresponding storage medium has not been changed and the volume information analysis result of the allocation information section 121 does not need to be updated. Therefore, when the controller calculates the capacity of the portable storage device, the controller scans and analyzes each of allocation information section 121 and records the analysis result of each allocation information section 121 in a volume allocation information analysis result storage area (not shown in the figure) in the controller. When the controller analyzes and calculates the allocation information, the controller accumulates the analysis result corresponding to each allocation information section 121 that the corresponding storage medium has not had any new data written in it and does not need to be updated. The controller merely reads the storage medium that the result entry is marked by a specified mark to indicate the corresponding allocation information section 121 is updated and needs to be scanned to obtain the updated allocation information. Therefore, if the storage medium 1 has had data under 10 MB written in it, the controller only needs to scan one allocation information section 121 (20 sectors). It does not need to scan the entire allocation information storage area (2048 sectors).

Alternatively, each section of the allocation information table 12 may be not identical, and the specified mark may be a flag mark.

Now, the ANSI C language is used as an example to illustrate the equivalent division of the storage medium 1. The capacity of the storage medium 1 is V (unit is sector). After the storage medium 1 is formatted, the file allocation table (FAT) is located at the start position S in the storage medium 1. The length of the file allocation table is L (unit is sector). The allocation information analysis result storage area in the control can store M sets of the allocation information sections 121. The formula for calculating the length N of the allocation information section 121 represented by each section analysis result is:

If ((L%M) != 0 ){

N = INT(L/M) + 1;

}else{

N=L/M;

}

It is noticed, when L % M !=0, the length N of the allocation information section 121 represented by a last section analysis result is:
N_last_entry =L % N;

By the above method, the controller reads and calculates the allocation information section 121 that has been written with the data and the allocation information has been changed to update the allocation information analysis result. It substantially reduces the required time for updating the allocation information and enhances the efficiency of the accessing operation.

However, when the portable storage device is turned on, it needs to scan the whole file allocation table 12. This influences the starting process and takes a longer time. On the other hand, when the size of the written data is large, it needs to scan several allocation information sections 121 and affects the efficiency of the accessing operations. Therefore, when the controller scans the allocation information sections 121, the number of the allocation information sections 121 scanned via the controller is limited. When the number of the allocation information sections 121 scanned via the controller reaches a predetermined value, the scanning process is interrupted and returns to the starting or accessing process. Because the updated section analysis result has been stored in the buffer area of controller, the controller directly accumulates the updated analysis result and merely scans the allocation information sections 121 that are not updated yet when the updating process is started again. By this method, the updating process is recycled until the whole allocation information sections are scanned or the allocation information sections 121 that need to be scanned are scanned. For example, the predetermined value for restricting the scanning number of the allocation information sections 121 is 10. After the controller scans 10 allocation information sections 121, the controller stores the analysis result in the buffer area of the controller and returns to the starting or reading/writing process. When the updating process is triggered again, the controller directly accumulates the updated result of allocation information sections 121 and scans the allocation information sections 121 that are not updated. Therefore, the influence produced by the scanning process for the file allocation table to the starting and reading/writing process is reduced.

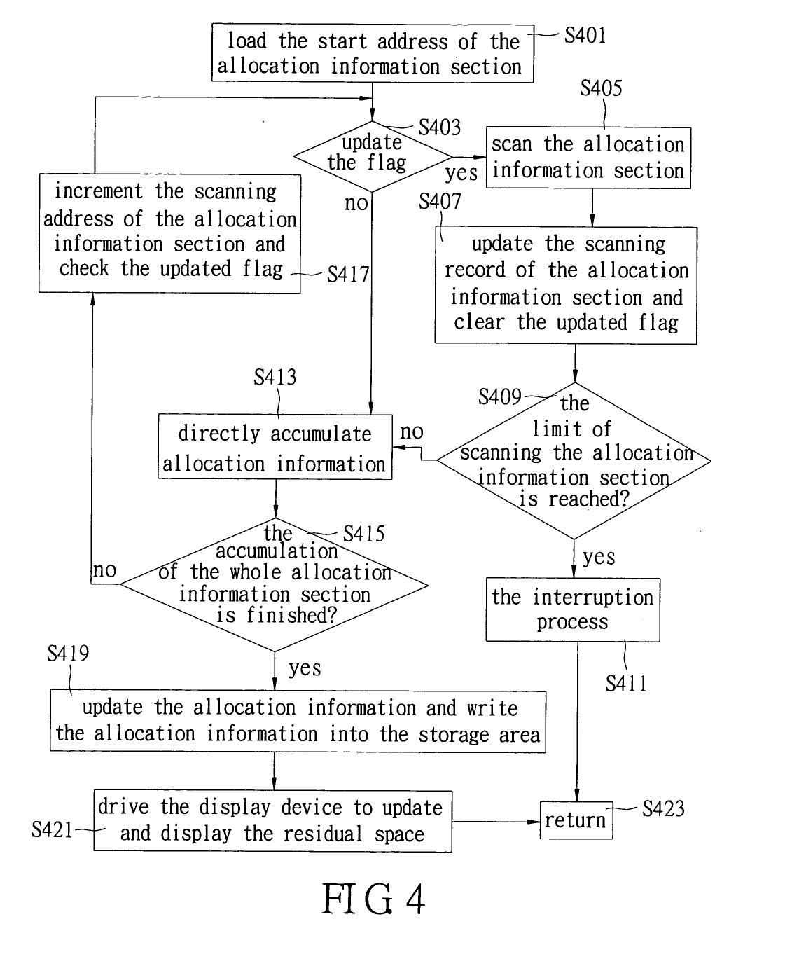

Please refer to FIG. 4, which shows a flow chart of restricting the number of scanning sections of the allocation information of a preferred embodiment of the present invention. Firstly, the starting address of the file allocation table is loaded from the buffer area of the controller (see step S401 in the FIG. 4). An updated flag in the result buffer for corresponding allocation information sections are checked to determine whether the allocation information sections need to be updated (see step S403 in the FIG. 4). If the analysis result for corresponding allocation information section needs to be updated, the allocation information section is scanned (see step S405 in the FIG. 4). Then, the analysis result of the allocation information section is updated and the updated flag is cleared (see step S407 in the FIG. 4). After the updated flag is cleared, whether or not the number of the scanned allocation information section reaches the limit is determined (see step S409 in the FIG. 4). If the number of the scanned allocation information section reaches the limit, the scanning process is interrupted with the updated result of the allocation information section stored in a result buffer area of the controller (see step S411 in the FIG. 4), then, operation returns to standby status (see step S423 in the FIG. 4). If the number of the scanned allocation information section does not reach the limit or the allocation information section does not need to be updated after the updated flag is checked, the analysis result of the allocation information sections are directly accumulated (see step S413 in the FIG. 4). After the analysis result of the allocation information sections is accumulated, whether or not the whole allocation information sections are accumulated is determined (see step S415 in the FIG. 4). If the whole allocation information sections are not yet accumulated, the scanning addressing of the allocation information sections is incremented. Then, the step S403 is repeated to check the updated flag of the next allocation information section (see step S417 in the FIG. 4). If the whole allocation information sections have been accumulated, the controller completely refreshed the analysis result to corresponding allocation information sections and stores the analysis results into a storage area in the storage medium (see step S419 in the FIG. 4). Then, the display device is driven to display the converted accumulated result of updated remaining available capacity (see step S421 in the FIG. 4), and returns to standby status (see step S423 in the FIG. 4).

By restricting the scanned number of the allocation information sections described as above, the maximum period of the updating process for the volume allocation information is restricted to avoid the normal starting or accessing process being affected. Because the updated analysis result of each allocation information section has been stored in result buffer of controller, the controller directly accumulates the updated analysis result for scanned allocation information sections and scans the allocation information section that is not updated when the updating process is started again.

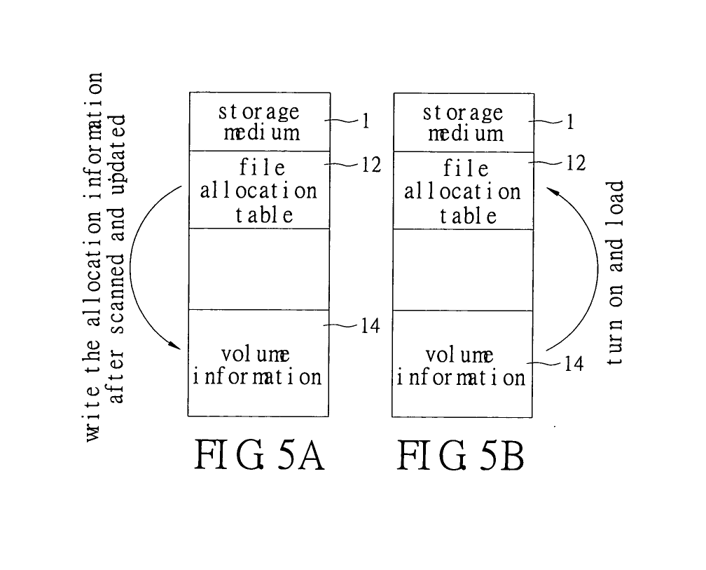

Please refer to FIG. 5A, which shows a schematic diagram of the operation for the volume information recording area of a preferred embodiment of the present invention. The present invention also provides a method to solve the problem of a starting time being delayed due to the portable storage device needing to scan the whole file allocation table during the starting process. There is a volume information analysis result recording area 14 in the storage medium 1 for recording the statistical result of the file allocation table. When the data is written into the storage medium to change the allocation information of the file allocation table 12, the controller scans the updated file allocation table 12 and stores the statistical result in the volume information analysis result recording area 14. Please refer to FIG. 5B, which shows a schematic diagram of another operation for the volume information recording area of a preferred embodiment of the present invention. When the storage device is started again, the latest updated result that is produced before the previous shut down of the storage device is directly loaded into the buffer area of the controller from the volume information recording area 14. The step of scanning the whole file allocation table 12 to update the volume allocation information is avoided when the storage device is started again and the controller can manage the allocation information to analyze and calculate the volume information of the storage device.

Alternatively, the file allocation table 12 also can be divided into multiple sections as above described to scan and update partially. The corresponding result buffer for sections of the file allocation table 12 that have been changed are marked by a specified mark. The specified mark is a flag mark. The controller scans the updated record of the file allocation table 12 according to the specified mark, analyzes and calculates the volume information of the storage device, and stores the analysis result and volume information in the volume information recording area 14.

When a host application system writes the data into the storage medium to change the file allocation table, an updating process is triggered to make the controller read the allocation information in the storage medium. However, when a host application system wants to write the data into the storage medium, the writing process are usually segmented into multiple transactions due to the limitation of connecting interface, communication protocol, instruction sets, size of the data buffer and the requirement of the multitasking operating system. This is also true even for data to be written into a continuous area.

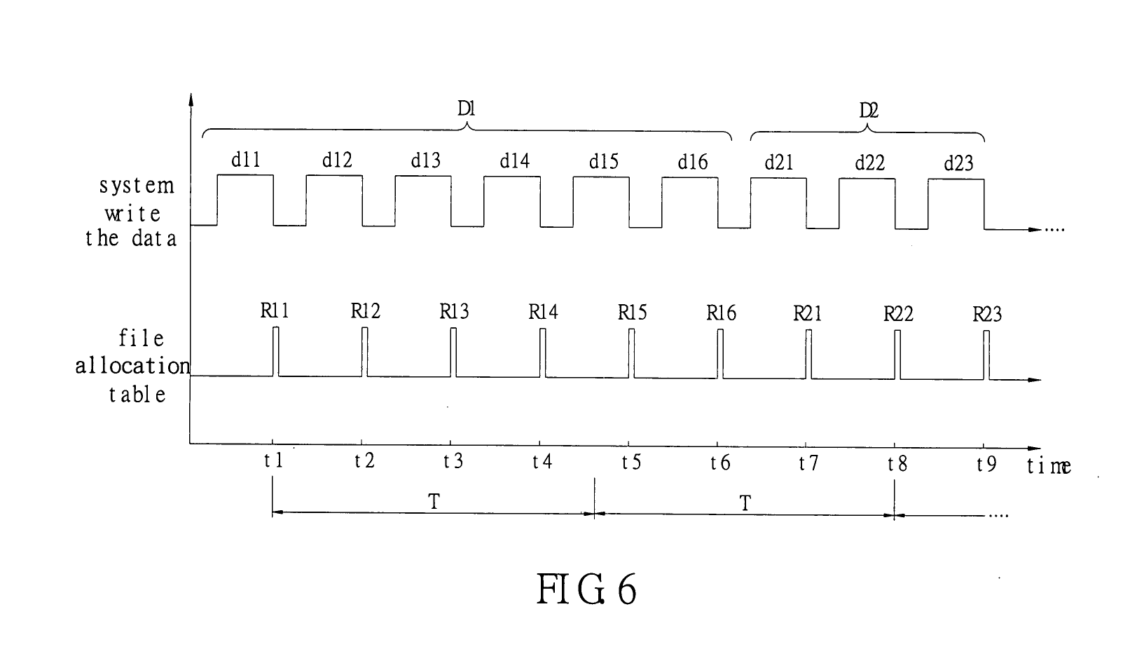

Please refer to FIG. 6, which shows a time chart of writing the data and triggering the updating process for the allocation information of a preferred embodiment of the present invention. Due to the above-described reasons, the data D1 is divided into data d11, data d12, data d13, data d14, data d15 and data d16, and then are written into the storage medium by the system. In the previous method, the updating signals are triggered (R11, R12, R13, R14, R15 and R16) to update the file allocation table when each data is written into the storage medium. However, the writing process is interrupted or halted many times to execute the updating process for the allocation information. The efficiency of the normal accessing process is thereby affected. Furthermore, if the time required for triggering and updating after the data is written is short, such as t1 is 0.1 sec and t2 is 0.2 sec, it is meaningless for the user to execute the updating process frequently within a short period of time.

Therefore, after the system writes the first data d11 of the data D1 into the storage medium, a first updating signal R11 is triggered to update the volume information. After the second data d11 of the data D1 is written into the storage medium, a second updating signal R12 is triggered to update the volume information. The process is repeated until the final data d16 of the data D1 is written into the storage medium and a sixth updating signal R12 is triggered to update the volume information. In order to reduce the frequency of updating process that affect the efficiency of the normal accessing process, some of the triggers are omitted. It utilizes the updating signal triggered by the first written data to trigger the timer count down operation for delaying the scanning process. When an updating signal appears with a delay period, the updating signal is not triggered to execute the scanning process. After the delay period elapsed, the updating operation is actually triggered to execute the scanning process and update the result buffer to correspond changes of file allocation table that has been modified by the written data during the delay period.

In other words, when the first data d11 of the data D1 is written to the storage medium and triggers a updating signal R11, a delay period T is counted and sets a flag to represent that the data d11 has been written into the storage medium and the file allocation table corresponding to the address of the storage medium written by the data d11 has been changed. During the delay period T, the updating signal R11, R12, R13 and R14 are not triggered to execute the updating process for the file allocation table and an updating flag individually marks the result buffer entries corresponding to the sections of file allocation table that has been changed. After the delay period passes, the analysis result buffer for file allocation table is updated according to the updating signals R11, R12, R13 and R14 triggered during the delay period. Then, after the data d15 is written, a updating signal R15 is triggered and a flag is used to mark the result buffer entry for corresponding file allocation table section. After the data d16 is written, a updating signal R16 is triggered and a flag is used to mark the result buffer entry for corresponding file allocation table section. Furthermore, after the data d21 of the data D2 is written, a updating signal R21 is triggered and a flag is used to mark the result buffer entry for corresponding file allocation table. However, the updating signals R15, R16 and R21 are triggered during the delay period T. When the delay period T elapsed, the result buffer entries for corresponding file allocation table sections are updated. Then, after the data d22 of the data D2 is written, an updating signal R22 is triggered and an updating signal R23 is triggered after the data d23 of the data D2 is written. A flag is used to individually mark the result buffer entry for corresponding file allocation table section. The file allocation table that has been changed during the delay period T is scanned and corresponding result buffer entry is updated when the delay period T passes. By the same method, the writing data and the updating process are continuously executed. The result buffer entries corresponding to file allocation table sections that has been changed during the delay period T is updated when the delay period T elapsed. Finally, the controller of the storage device complete scanning and analyzing the volume information of the storage medium according to the updating flag of the file allocation table.

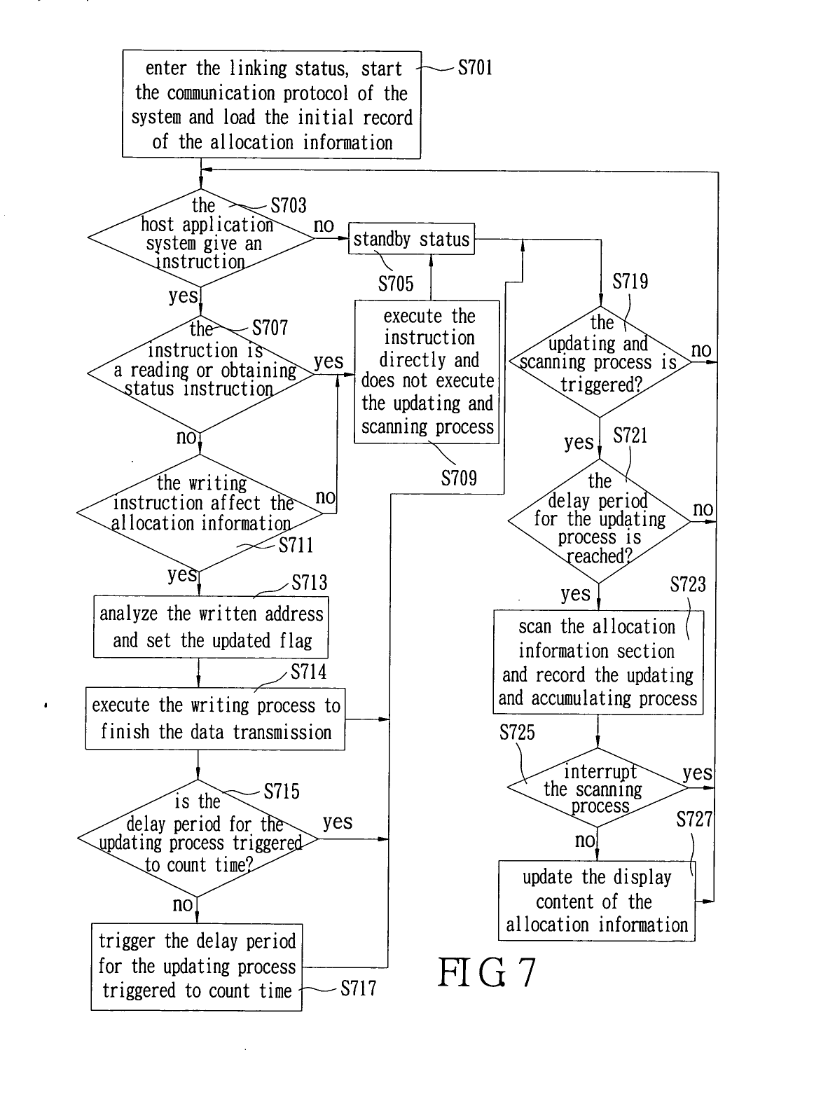

Please refer to FIG. 7, which shows a flow chart of delaying the trigger of an updating process for the allocation information of a preferred embodiment of the present invention. Firstly, the portable storage device is linked with a host application system. The communication protocol of the system is started and an initial record of the analysis result of allocation information stored in the storage medium is loaded into the controller (see step S701 in the FIG. 7). Whether or not the host application system sends an instruction is checked (see step S703 in the FIG. 7). If the host application system does not give an instruction, the step S705 is executed to switch the portable storage device to a standby status (see step S705 in the FIG. 7). After the portable storage device enters the standby status, whether an updating signal is triggered or not is determined (see step S719 in the FIG. 7). If the host application system sends an instruction, whether the instruction is a reading or obtaining status instruction is determined (see step S707 in the FIG. 7). If the instruction is a reading or obtaining status instruction, the instruction is directly executed and the updating process for scanning the file allocation table is not executed (see step S709 in the FIG. 7), and returns to the step S705. If the instruction is not a reading or obtaining status instruction, whether or not the instruction changes the file allocation table is determined (see step S711 in the FIG. 7). If the instruction does not change the file allocation table, then step S709 is executed. If the instruction changes the file allocation table, the address written by the instruction is analyzed and an updating flag is set (see step S713 in the FIG. 7) to the analysis result buffer. Then, the writing process is executed to finish the data transmission (see step S714 in the FIG. 7). Whether or not a delay period is elapsed to delay the updating process is then determined (see step S715 in the FIG. 7). If the delay period has not already started to count down pre-determined period of time, the timer to count down delay period is started to count down this period of time (see step S717 in the FIG. 7). After the process is finished, whether the updating signal is triggered or not is determined (see step S719 in the FIG. 7). If the updating signal is not triggered yet, the process returns to step S703. If the updating signal is triggered, whether the delay period for delaying the updating process is reached or not is determined (see step S721 in the FIG. 7). If the delay period is not reached yet, the process returns to step S703. In standby status, whether or not the delay period for delaying the updating process is reached or not is continuously checked. If the delay period is reached, the controller scans the sections of the file allocation table according to the updated flag and records the updating and accumulating process (see step S723 in the FIG. 7). Whether the scanning process should be interrupted or not is then determined (see step S725 in the FIG. 7). This is determined according to whether the number of the scanned sections has reached the limit or not. If the scanning process is to be interrupted, the process returns to step S703 to check whether or not the portable storage device has received an instruction from the host application system and to execute the host instruction with a first priority. If the scanning process has not been interrupted or completed after interruption, the indication on the display for the allocation information is updated.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. A method for analyzing the storage capacity of a portable storage device, that the method utilizes a controller to scan a file allocation table to analyze the capacity of a storage medium, the steps comprising:
dividing a file allocation table of the storage medium into several allocation information sections;
setting an updating signal to represent the allocation information section that has been changed, when the data is written into the storage medium to make the allocation information section change;
scanning the file allocation table via the controller according to the allocation information section set by the updating signal, and reading the allocation information of the allocation information section; and
not scanning the file allocation table via the controller according to the allocation information section that is not set by the updating signal, and accumulating directly the formerly stored allocation information of the allocation information section.

2. The method for analyzing the storage capacity of a portable storage device as claimed in claim 1, wherein the length of each allocation information section is identical.

3. The method for analyzing the storage capacity of a portable storage device as claimed in claim 1, wherein the length of each allocation information section is not identical.

4. The method for analyzing the storage capacity of a portable storage device as claimed in claim 1, wherein the updating signal is a digitized representation.

5. The method for analyzing the storage capacity of a portable storage device as claimed in claim 1, wherein the controller stores the allocation information analysis result of the scanned allocation information section in a buffer area of the controller.

6. A method for analyzing the storage capacity of a portable storage device, the steps comprising:
providing a limit for number of scanned allocation information sections;
loading the start address of the scanning record corresponding to the allocation information section;
checking whether the allocation information section needs to be updated;
scanning the allocation information section, if the allocation information section needs to be updated;
updating the scanning record of the allocation information section after the allocation information section is scanned;
determining whether the limit of scanned allocation information sections is reached after the scanning record of the allocation information section is updated;
interrupting the process and returning to the standby status if the limit of scanned allocation information sections is reached;
accumulating directly the allocation information of the allocation information section if the allocation information section does not need to be updated or if the limit of scanned allocation information sections is not reached; and
checking whether the whole allocation information sections have been accumulated.

7. The method for analyzing the storage capacity of a portable storage device as claimed in claim 6, wherein if the result of the step of checking whether the whole allocation information sections have been accumulated is negative, the scanning address of the allocation information section is incremented and to checks whether the next accumulated allocation information section needs to be updated or not.

8. The method for analyzing the storage capacity of a portable storage device as claimed in claim 6, wherein if the whole allocation information sections have been accumulated, the allocation information is updated and stored into a buffer area of the controller.

9. The method for analyzing the storage capacity of a portable storage device as claimed in claim 6, wherein after the allocation information is updated and stored into the buffer area, a display device is driven to update the display of the residual capacity.

10. The method for analyzing the storage capacity of a portable storage device as claimed in claim 6, wherein the start address of the scanning record of the allocation information section is loaded from a buffer area of the controller.

11. The method for analyzing the storage capacity of a portable storage device as claimed in claim 6, wherein the scanned allocation information section is divided from the scanned file allocation table.

12. The method for analyzing the storage capacity of a portable storage device as claimed in claim 6, wherein the limit of scanned allocation information sections sets the limiting number of the scanned allocation information sections.

13. The method for analyzing the storage capacity of a portable storage device as claimed in claim 6, wherein the length of each allocation information section is identical.

14. The method for analyzing the storage capacity of a portable storage device as claimed in claim 6, wherein the length of each allocation information section is not identical.

15. The method for analyzing the storage capacity of a portable storage device as claimed in claim 6, wherein the step of checking whether the allocation information section needs to be updated or not is determined by checking an digitized representation.

16. The method for analyzing the storage capacity of a portable storage device as claimed in claim 15, wherein when the allocation information section is changed, the digitized representation is set.

17. A method for analyzing the storage capacity of a portable storage device, the steps comprising:
determining whether the writing instruction from a host application system to the portable storage device affects a file allocation table of a storage medium in the portable storage device;
analyzing the file allocation table that corresponds to the written data, and setting a mark signal;
triggering a counting time to count the delay period;
updating the scanned file allocation table that needs to be updated during the delay period, when the delay period is reached; and
scanning the file allocation table to update the record of the storage capacity of portable storage device.

18. The method for analyzing the storage capacity of a portable storage device as claimed in claim 17, wherein the mark signal is a digitized representation.

19. The method for analyzing the storage capacity of a portable storage device as claimed in claim 17, wherein a delay period is triggered to count time after the host application system writes the first data into the storage medium to make the file allocation table change.

20. The method for analyzing the storage capacity of a portable storage device as claimed in claim 17, wherein the updating process for the allocation information is not executed during the delay period even though the data is written, and the file allocation table that has been changed during the delay period is updated until the delay period is reached.

21. The method for analyzing the storage capacity of a portable storage device as claimed in claim 17, wherein a controller reads and analyzes the file allocation table according to the mark signal for updating the record of the storage capacity of the portable storage device.

22. The method for analyzing the storage capacity of a portable storage device as claimed in claim 12, wherein the record of the storage capacity of the portable storage device is stored in a buffer area of the controller.

23. A method for analyzing the storage capacity of a portable storage device, the steps comprising:
setting a volume information record area in a storage medium;
loading the volume information into a controller from the volume information record area, when the portable storage device is turned on;
scanning the allocation information area via the controller and updating the volume information when the data is written into an allocation information area to change the allocation information; and
storing the updated volume information in the volume information record area after the controller scanning the allocation information area and updates the volume information.

24. The method for analyzing the storage capacity of a portable storage device as claimed in claim 23, wherein when the allocation information of the allocation information area is changed, a mark signal is used to mark the change.

25. The method for analyzing the storage capacity of a portable storage device as claimed in claim 24, wherein the mark signal is a digitized representation.

26. The method for analyzing the storage capacity of a portable storage device as claimed in claim 24, wherein the controller scans and updates the record of the allocation information area according to the mark signal.

27. The method for analyzing the storage capacity of a portable storage device as claimed in claim 23, wherein the allocation information area is divided into multiple sections for being scanned and updated independently by the controller.

28. The method for analyzing the storage capacity of a portable storage device as claimed in claim 27, wherein the length of each allocation information section is identical.

29. The method for analyzing the storage capacity of a portable storage device as claimed in claim 27, wherein the length of each allocation information section is not identical.
